(19) United States
(12) Patent Application Publication
(10) Pub. No.: US 2017/0251083 A1
(43) Pub. Date: Aug. 31, 2017

(54) DATA STORAGE OVER FIBRE CHANNEL

(71) Applicant: HEWLETT PACKARD ENTERPRISE DEVELOPMENT LP, Houston, TX (US)

(72) Inventors: Matthew Jack BURBRIDGE, Stoke Gifford Bristol (GB); Andrew TODD, Stoke Gifford Bristol (GB); Craig DRISCOLL, Stoke Gifford Bristol (GB)

(73) Assignee: HEWLETT PACKARD ENTERPRISE DEVELOPMENT LP, Houston, TX (US)

(21) Appl. No.: 15/500,032

(22) PCT Filed: Sep. 5, 2014
(86) PCT No.: PCT/US2014/054174

§ 371 Date: Jan. 28, 2017

(51) Int. Cl. H04L 29/06; G06F 9/54; G06F 13/42; H04L 29/08; H04L 12/931

(52) U.S. Cl. CPC H04L 69/18; H04L 67/1097; H04L 49/70; G06F 13/426; G06F 9/54; H04L 2212/00

(57) ABSTRACT

In some examples, a server receives, from a client running data storage software, an Ethernet payload encapsulated in a Fibre Channel Small Computer System Interface payload transmitted over FC. In some examples, the extracted Ethernet payload is forwarded to a virtualized Ethernet network device on the server and the virtualized Ethernet network device is interfaced with the data storage software of the client.

### BACKGROUND

Storage area networks (SANs) are often designed for use in data centers or other locations to allow networked devices access to one or more storage devices for data backup, recovery, and other uses. Although some SANs rely on Internet Protocol (IP) network infrastructure (e.g., Ethernet ports/cables and related commands) for intra-network communication, many SANs instead rely on Fibre Channel (FC) infrastructure (e.g., SCSI ports/cables and related commands) for such communication. In addition, some SANs rely on both IP and FC infrastructure. For example, such a SAN can use IP infrastructure for communication between a storage server and a storage client running data storage software, and use FC infrastructure for communication between the storage server and a storage device, such as a tape library.

### BRIEF DESCRIPTION OF DRAWINGS

FIG. 1 is a diagram of a storage area network containing a storage server, according to an example.

FIG. 2 is a flowchart of a method relating to transmitting Ethernet payloads for data storage software to a storage server over Fibre Channel infrastructure, according to an example.

FIG. 3 is a diagram of a storage server, according to an example.

FIG. 4 is a diagram of storage area network containing a storage server, according to an example.

FIG. 5 is a diagram illustrating various aspects of a storage server during operation, according to an example.

FIG. 6 illustrates a first portion of a use case in which data is transferred between a host and target in a storage area network, according to an example.

FIG. 7 illustrates a second portion of a use case in which data is transferred between a host and target in a storage area network, according to an example.

### DETAILED DESCRIPTION

In some SANs, storage devices (e.g., disk arrays, tape libraries, etc.) are interfaced with storage servers to allow the storage server to store and retrieve data on the storage device. The storage servers can further be interfaced with storage clients to respond to storage-related requests from the storage client. For example, a storage client can instruct a storage server to retrieve data stored on the storage device and provide the data to the storage client as part of a data recovery process. As another example, the storage client can send data to the storage server and instruct the storage server to store the data on the storage device as part of a data backup process.

Data storage software has been designed that can improve the usefulness of such SANs. As but one example, some data storage software can be used to perform data deduplication, which is a process that can involve comparing blocks of data being written to storage devices with blocks of data previously stored on one or more storage devices. In one example, data storage software comprises computer or processor machine readable instructions executable by a computer or processor. In such a process, when duplicate data is found, a pointer can be established to the original data, rather than storing the duplicate data sets. As a result, the amount of storage space used to store a chunk of data can be reduced. Although data storage software has been designed to allow such deduplication to be performed by various devices within a SAN, client-side deduplication can be especially advantageous as it can reduce the amount of data transferred over the storage infrastructure between a storage client and storage server. That is, rather than transferring a full stream of duplicated data between a storage client and storage server, when client-side deduplication is used, a reduced (i.e., deduplicated) stream of data is transferred between the storage client and the storage server.

Data storage software installed on the storage client can be programmed to interface with the storage server via an Internet Socket Application Programming Interface (API) over IP infrastructure (e.g., Ethernet ports/cables), to transmit IP traffic (e.g., Ethernet traffic). Because networked devices in SANs are often designed to communicate via FC infrastructure, the additional use of IP infrastructure to transmit IP traffic relating to the data storage software can, in some instances, lead to increased costs and administrative demands on the network. For example, in some data centers, storage administrators are responsible for administering FC-related aspects of the data center, with distinct network administrators being responsible for administering IP-related aspects of the data center. Moreover, some data centers outsource storage management and network management to different companies. As a result, data backup software that relies on both IP and FC infrastructure in a SAN can be expensive and administratively burdensome.

Certain implementations of the present disclosure are intended to address the above issues by providing a storage server that is able to interface over FC infrastructure with data storage software on a storage client. For example, in certain implementations, an Ethernet payload is received from the storage client over FC infrastructure. The Ethernet payload can be encapsulated in an FC SCSI payload, extracted from the SCSI payload by the storage server, and then forwarded to a virtualized Ethernet network device on the storage server. The virtualized Ethernet network device can then be interfaced with data storage software on the storage client. In some implementations, the use of such encapsulated Ethernet payloads and virtualized Ethernet network devices can allow a storage server to interact with data storage software on a storage client over FC infrastructure without relying on developers to modify the code of the data storage software. Moreover, because FC infrastructure alone can be used instead of a combination of FC and IP infrastructure, the costs of such a SAN can be reduced and its administration can be simplified. Further details of this implementation and its associated advantages, as well as other implementations and their advantages, will be discussed in more detail below.

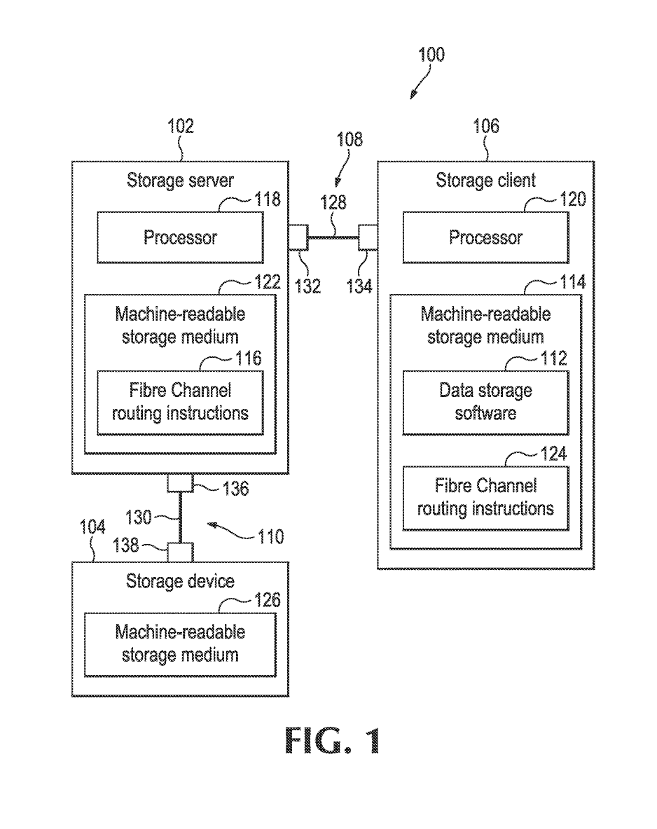

FIG. 1 is a diagram of a storage area network (SAN) 100 containing a storage server 102 in communication with a storage device 104 and a storage client 106 via FC infrastructure 108 and 110. A Point-to-point (FC-P2P) topology of SAN 100 is provided as an example. In this type of topology, two devices (e.g., storage server 102 and storage client 106) are connected directly to each other. It is appreciated that this disclosure may apply to other suitable topologies of SAN 100, such as suitable arbitrated loop (FC-AL) topologies, in which network devices are in a loop or ring, and switched fabric (FC-SW) topology, in which network devices are connected to fibre channel switches.

Storage server 102 and storage client 106 can be in the form of suitable servers, desktop computers, laptops, or other electronic devices. For example, in some implementations, storage server 102 is in the form of a standalone storage server appliance, with storage client 106 being in the form of a desktop computer including a monitor for presenting information to an operator and a keyboard and mouse for receiving input from an operator. In some implementations, a storage server appliance includes a common housing containing both storage server 102 and storage device 104. Such a storage appliance can, for example, be mounted on a server rack and include a base couplet containing multiple server nodes (e.g., two server nodes) and multiple dual controller disk arrays (e.g., two arrays) with each array containing multiple disks (e.g., twelve disks). In some implementations, additional storage, such as additional disk arrays can be added to the storage appliance.

Storage device 104 is interfaced with storage server 102 and can, for example, be in the form of a tape library, disk array, or another suitable type of storage device containing a machine-readable storage medium 126. For example, storage device 104 can be in the form of tertiary storage that can, for example, be mounted and dismounted via a robotic mechanism according to the demands of storage device 104. Storage device 104 can, for example, be used for archiving rarely accessed information and can include machine-readable storage mediums designed for large data stores. In order to read information from such tertiary storage, storage server 102 or another computer can be designed to first consult a catalog database to determine which medium (e.g., tape or disc) of storage device 104 contains the information. Next, storage server 102 or another computer can instruct a robotic arm to fetch the medium and place it in a drive, or other reader mechanism. When storage server 102 or another computer has finished reading the information from the medium, the robotic arm can return the medium to its place in the library. Storage device 104 can using standard SCSI commands (e.g. INQUIRY) and responds to a set of specific SCSI commands.

Storage server 102 and storage client 106 include respective processors 118 and 120, as well as respective machine-readable storage mediums 122 and 114 as described further below. Each processor can, for example, be in the form of a central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. Each processor can, for example, include single or multiple cores on a chip, multiple cores across multiple chips, multiple cores across multiple devices, or suitable combinations thereof. Each processor can be functional to fetch, decode, and execute instructions as described herein. As an alternative or in addition to retrieving and executing instructions, each processor can, for example, include at least one integrated circuit (IC), other control logic, other electronic circuits, or suitable combination thereof that include a number of electronic components for performing the functionality of instructions stored on a storage medium. Each processor can, for example, be implemented across multiple processing units and instructions may be implemented by different processing units in different areas of storage server 102 or storage client 106.

One or more mediums of storage server 102 and storage client 106 can, for example, be in the form of a non-transitory machine-readable storage medium, such as a suitable electronic, magnetic, optical, or other physical storage apparatus to contain or store information such as FC routing instructions 116 for storage server 102, data storage software 112 for storage client 106, FC routing instructions 124 for storage client 106, related data, and the like. It is appreciated that data stored in storage server 102 can be stored on separate machine-readable storage mediums. For example, FC routing instructions 116 can be stored on a first machine-readable storage medium, such as a hard drive, and data for archiving can be stored on a second machine-readable storage medium, such as a tape library housed within a common housing of storage server 102. Data for archiving can be stored on a second machine-readable storage medium housed in a housing separate from storage server 102 (e.g., on storage device 104). For purposes of description herein, multiple storage mediums of storage server 102 can be identified as a single storage medium 122.

As used herein, the term “machine-readable storage medium” can, for example, include Random Access Memory (RAM), flash memory, a storage drive (e.g., a hard disk), tape libraries, any type of storage disc (e.g., a Compact Disc Read Only Memory (CD-ROM), any other type of compact disc, a DVD, etc.), and the like, or a combination thereof. In some implementations, a storage medium can correspond to a memory including a main memory, such as a Random Access Memory (RAM), where software may reside during runtime, and a secondary memory. The secondary memory can, for example, include a nonvolatile memory where a copy of software or other data, such as data for archiving, is stored.

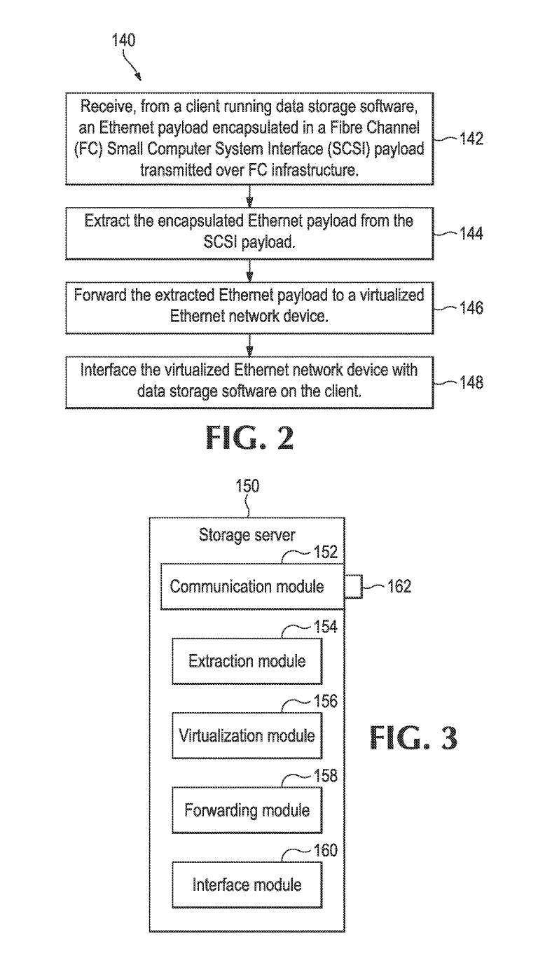

FC routing instructions 116 for storage server 102 can be executable by processor 118 such that storage server 102 is operative to perform one or more functions described herein, such as those described below with respect to the method of FIG. 2. For example, in some implementations, FC routing instructions 116 can include: (1) instructions to virtualize an Ethernet network device on storage server 102, (2) instructions to extract an encapsulated Ethernet payload from an FC Small Computer System Interface (SCSI) payload, (3) instructions to forward the extracted Ethernet payload to the virtualized Ethernet network device, and (4) instructions to interface the virtualized Ethernet network device with data storage software of storage client 106.

Data storage software 112 is installed on storage client 106 and can, for example, be used to facilitate backup and recovery process. In some implementations, data storage software 112 can allow an operator to centrally manage and protect data scattered across remote sites and data centers in physical, virtual, and cloud infrastructures. In some implementations, data storage software 112 can provide client-side deduplication, and/or allow an operator to create disaster recovery images from an existing file system or image backup. In some implementations, data storage software can be used to span a backup store across multiple nodes to balance capacity, performance and growth across a storage infrastructure. Data storage software 112 can, for example, be provide an application programming interface (API) that allows interaction with storage server 102 using remote procedure calls.

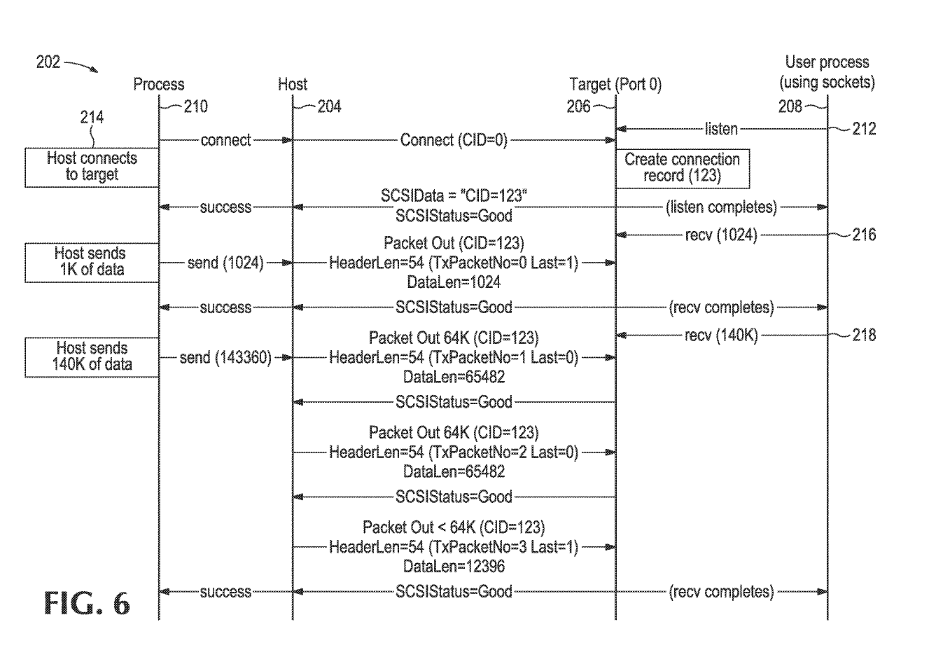

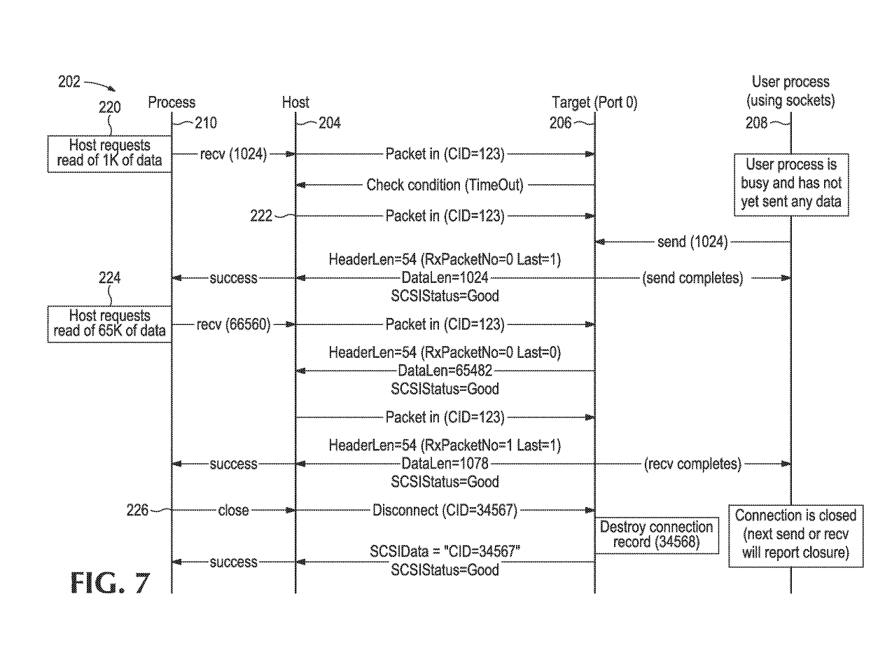

Separate from FC routing instructions 116 on storage server, a second set of FC routing instructions 124 can be installed on storage client 106 allow an Ethernet payload for data storage software 112 to be encapsulated in a FC SCSI payload for transmitting over FC infrastructure. FC routing instructions 124 can, for example, implement an API that maps socket-link commands (e.g., socket, connect, send, recv, close) to SCSI commands that are interpreted by storage server 102. An example use case of such socket-link mapping is described below with respect to FIGS. 6 and 7.

As described above, storage server 102 is connected to storage client 106 and storage device 104 via FC infrastructure 108 and 110. For the sake of illustration, FIG. 1 depicts that FC infrastructure 108 includes only a single cable connecting storage client 106 and storage server 102, and a single cable connecting storage server 102 and storage device 104. However, other suitable FC infrastructure can be used to connect these network elements. For example, it is appreciated that many implementations of SAN 100 will include more complicated FC infrastructure connecting storage server 102 and storage client 106. For example, in some implementations, storage client 106 can be connected to storage server 102 via one or more intermediary devices in a storage area network, such as network switches, routers, gateways, etc., and that multiple FC cables can be used in the connection.

FC cable 128 can connect storage server 102 to storage client 106 and FC cable 130 can connect storage server 102 to storage device 104. The FC cables can, for example, be in the form of an electrical or fiber-optic cable. The FC cables can, for example, be compatible with single-mode fiber or multimode fiber modality. The fiber diameter of the FC cables can, for example, be 62.5 μm, 50 μm, or another suitable diameter. It is appreciated that other suitable types of FC cables can be used.

FC cable 128 is connected to storage server 102 via an FC port 132 of storage server 102 and is connected to storage client 106 via an FC port 134 of storage client 106. FC cable 130 is connected to storage server 102 via an FC port 136 of storage server 102 and connected to storage device 104 via an FC port 138 of storage device 104. Each port can be used for receiving and sending data within SAN 100. Each port can be in the form of a node port (e.g., N_port), for use with Point-to-Point or switched fabric topologies, a Node Loop port (e.g., NL_port), for use with Arbitrated Loop topologies, or another suitable type of port for a SAN. Storage server 102, storage client 106, and storage device 104 can interface with their respective ports via the use of a host bus adapter (HBA) to connect to Fibre Channel devices, such as SCSI devices.

FIG. 2 illustrates a flowchart for a method 140 relating to the use of a storage server. The description of method 140 and its component steps make reference to elements of example SAN 100, such as storage server 102, storage client 106, and storage device 104 for illustration, however, it is appreciated that this method can be used for any suitable network or network element described herein or otherwise.

Method 140 includes a step 142 of storage server 102 receiving, from storage client 106 running data storage software, an Ethernet payload encapsulated in a FC SCSI payload transmitted over FC infrastructure. As described above, FC routing instructions 124 on storage client 106 can be executed by processor 120 of storage client 106 to encapsulate an Ethernet payload within an FC SCSI payload for transmitting over FC infrastructure. For example, FC routing instructions 124 of storage client 106 can implement an API that maps socket-link commands (socket, connect, send, recv, close) to SCSI commands that are interpreted by storage server 102. In some implementations of step 142, data is transferred over FC infrastructure from storage client 106 to storage server 102 using SCSI commands. To receive data from storage server 102, storage client 106 can post a SCSI command and wait for data. An example of such a process is described below with respect to FIGS. 6 and 7.

In some implementations, data in the Ethernet payload can be deduplicated data. Such deduplicated data can be deduplicated by storage client 106 via data storage software 112 installed on storage client 106 or from software installed on another machine. It is appreciated that other types of data can be provided in the Ethernet payload received by storage server 102 from storage client 106.

Method 140 includes a step 144 of storage server 102 extracting the encapsulated Ethernet payload from the SCSI payload. For example, in some implementations where storage client 106 maps socket-link commands to SCSI commands, step 144 can include mapping the SCSI commands to socket-link commands suitable for use with Ethernet network devices. In some implementations, an entire Ethernet packet, including an Ethernet header and payload is encapsulated within a SCSI payload. In such implementations, step 144 can include stripping the SCSI payload of its SCSI header and other elements to result in the Ethernet packet containing the Ethernet header and payload.

Method 140 includes a step 146 of storage server 102 forwarding the extracted Ethernet payload to a virtualized Ethernet network device. The virtualized Ethernet network device is virtualized on storage server 102 and can, for example, be created by storage server 102 or another machine. In some implementations, storage server 102 can create multiple virtualized Ethernet devices, such as a first virtual Ethernet device and a second virtual Ethernet device to run on storage server 102. In implementations where multiple virtual Ethernet devices are created, method 140 can include a step of assigning a first Unique Target Identifier (UTID) to the first virtualized Ethernet network device and assigning a second UTID to the second virtualized Ethernet network device. In such implementations, method 140 can include a further step of determining whether the extracted Ethernet payload should be forwarded to the first or second Ethernet device based on metadata in the Ethernet payload. For example, the metadata can include a destination address that identifies the first or second UTID.

Method 140 includes a step 146 of storage server 102 interfacing the virtualized Ethernet network device with data storage software on storage client 106. Step 146 can include interfacing the virtualized Ethernet network device with data storage software via an Internet Socket Application Programming Interface (API). After such interfacing, processes that already use the Internet Socket API (e.g., Linux Socket API) can make use of the virtualized Ethernet network device without relying on code modifications. In some implementations, the virtualized Ethernet network device is configurable by the data storage software via socket API commands. For example, existing Linux network configuration and diagnostic tools (e.g. ifconfig and tcpdump) can be used.

In some implementations, method 140 can include a step of storage server 102 storing data received from storage client 106 onto storage device 104. Likewise, in some implementations, method 140 can include a step of storage server 102 retrieving data stored on storage device 104 and sending the retrieved data to storage client 106. Storage server 102 can, for example, communicate with storage device using FC commands, such as SCSI commands. In this context, storage server 102 can serve the role of SCSI initiator, with storage device 104 serving the role of SCSI target. FIGS. 6 and 7 illustrate examples of SCSI commands performed by storage device 104, such as sending data to storage device 104 and receiving data from storage device 104.

FIG. 3 is a diagram of a storage server 150 according to an example in the form of functional modules that are operative to execute one or more computer instructions described herein. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or at hardware and software hosted at hardware. Additionally, as used herein, the singular forms “a,” “an,” and “the” include plural referents unless the context clearly dictates otherwise. Thus, for example, the term “module” is intended to mean one or more modules or a combination of modules. Each module of storage server 150 can include one or more machine-readable storage mediums and one or more computer processors. For example, software that provides the functionality of modules on storage server 150 can be stored on a memory of a computer to be executed by a processor of the computer. Storage server 150 of FIG. 3, which is described in terms of functional modules containing hardware and software, can include one or more structural or functional aspects of storage server 102 of FIG. 1, which is described in terms of processors and machine-readable storage mediums.

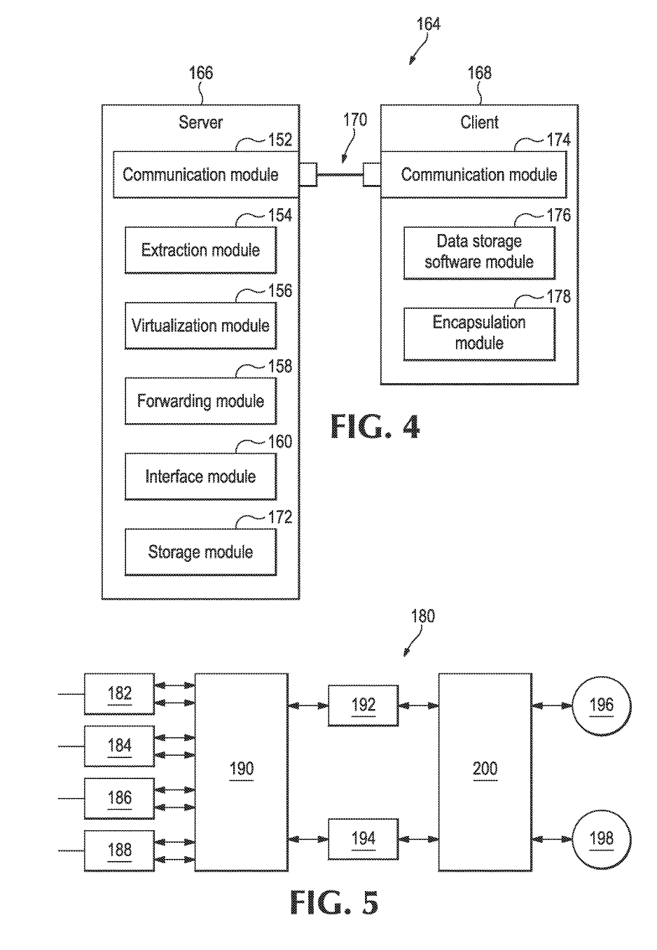

In some implementations, storage server 150 includes a communication module 152, extraction module 154, virtualization module 156, forwarding module 158, and an interface module 160. Each of these aspects of storage server 150 will be described below. It is appreciated that other modules can be added to storage server 150 for additional or alternative functionality. For example, another implementation of a storage server (described with respect to FIG. 4) includes additional modules, such as a storage module.

Communication module 152 is a functional module of storage server 150 that includes a combination of hardware and software that allows server to connect to a client to receive, from a storage client running data storage software, an Ethernet payload encapsulated within an FC Small Computer System Interface (SCSI) payload. In some implementations, communication module 152 is configured to provide communication functionality related to step 142 of method 140 described above. In the implementation of FIG. 3, communication module 152 includes a Fibre Channel (FC) port 162 to connect to FC infrastructure to connect storage server 150 to a storage client running data storage software. In some implementations, communication module 152 includes hardware in the form of a microprocessor on a single integrated circuit, related firmware, and other software for allowing the microprocessor to operatively communicate with other hardware of storage server 150.

Extraction module 154 is a functional module of storage server 150 that includes a combination of hardware and software that allows storage server 150 to extract the Ethernet payload from the SCSI payload. In some implementations, extraction module 154 is configured to provide extraction functionality related to step 144 of method 140 described above. Extraction module 154 can, for example, include hardware in the form of a microprocessor on a single integrated circuit, related firmware, and other software for allowing the microprocessor to operatively communicate with other hardware of storage server 150. In some implementations, extraction module 154 is configured to extract multiple Ethernet commands from a single SCSI payload and/or a single Ethernet command from multiple SCSI payloads.

Virtualization module 156 is a functional module of storage server 150 that includes a combination of hardware and software that allows storage server 150 to virtualize an Ethernet network device. In some implementations, virtualization module 156 is configured to provide virtualization functionality related to the virtualization steps described above with respect to method 140. For example, virtualization module 156 can, for example, virtualize first and second Ethernet network devices on storage server 150. Moreover, virtualization module 156 can, for example, assign the first Ethernet network device a first Unique Target Identifier (UTID) and the second Ethernet network device a second UTID for forwarding Ethernet payloads received from a storage client. In some implementations, virtualization module 156 includes hardware in the form of a microprocessor on a single integrated circuit, related firmware, and other software for allowing the microprocessor to operatively communicate with other hardware of storage server 150.

Forwarding module 158 is a functional module of storage server 150 that includes a combination of hardware and software that allows storage server 150 to forward the Ethernet payload to the virtualized Ethernet network device. In some implementations, forwarding module 158 is configured to provide forwarding functionality related to step 146 of method 140 described above. Forwarding module 158 can, for example, include hardware in the form of a microprocessor on a single integrated circuit, related firmware, and other software for allowing the microprocessor to operatively communicate with other hardware of storage server 150. In implementations where virtualization module 156 virtualizes first and second Ethernet network devices on the server, forwarding module 158 can, for example, determine whether to forward the extracted Ethernet payload to the first virtualized Ethernet network device or the second virtualized Ethernet network device based on metadata in the extracted Ethernet payload. In some implementations, forwarding module 158 forwards the extracted Ethernet payload to the determined Ethernet network device.

Interface module 160 is a functional module of storage server 150 that includes a combination of hardware and software that allows storage server 150 to interface the virtualized Ethernet network device with data storage software. In some implementations, interface module 160 is configured to provide interfacing functionality, such as functionality related to step 148 of method 140 described above. In some implementations, interface module 160 includes hardware in the form of a microprocessor on a single integrated circuit, related firmware, and other software for allowing the microprocessor to operatively communicate with other hardware of storage server 150.

FIG. 4 illustrates an example of a storage area network (SAN) 164 including another implementation of a storage server 166 connected to a storage client 168 via FC infrastructure 170. Storage server 166 and storage client 168 of FIG. 4, which are described in terms of functional modules containing hardware and software, can include one or more structural or functional aspects of storage server 102 and storage client 106 of FIG. 1, which are described in terms of processors and machine-readable storage mediums.

Storage server 166 as depicted in FIG. 4 includes communication module 152, extraction module 154, virtualization module 156, forwarding module 158, and interface module 160, which are described above with respect to FIG. 3. Although the description of storage server 166 refers to elements of storage server 150 for illustration, it is appreciated that certain implementations of storage server 166 can include alternative and/or additional features than those expressly described with respect to storage server 166. For example, as described further below, storage server 166 can include a storage module 172.

Storage module 172 is a functional module of storage server 166 that includes a combination of hardware and software to archive and restore data. Storage module 172 can include hardware and software described above with respect to storage device 104, and can, for example, be in the form of a tape library, disk array, or another suitable type of storage device containing a machine-readable storage medium. Storage module 172 can, for example, archive data on a Small Computer System Interface (SCSI) storage device via SCSI commands.

Storage client 168 includes a communication module 174 and data storage software module 176 containing data storage software 112, examples of which are described above with respect to FIG. 1. Communication module 174 and data storage software module 176 are described further below. It is appreciated that other modules can be added to storage server 166 for additional or alternative functionality. As but one example, storage client 168 may include an I/O module including hardware and software relating to input and output, such as a monitor, keyboard, and mouse, which can allow an operator to interact with storage client 168.

Communication module 174 is a functional module of storage client 168 that includes a combination of hardware and software that allows storage client 168 to connect to storage server 166 to send an Ethernet payload encapsulated within an FC Small Computer System Interface (SCSI) payload. In some implementations, communication module 174 is configured to provide communication functionality regarding storage client 168 described above with respect to step 142 of method 140. In the implementation of FIG. 4, communication module 174 includes a Fibre Channel (FC) port to connect to FC infrastructure 170. In some implementations, communication module 174 includes hardware in the form of a microprocessor on a single integrated circuit, related firmware, and other software for allowing the microprocessor to operatively communicate with other hardware of storage client 168.

Data storage software module 176 is a functional module of storage client 168 that includes a combination of hardware and software that allows storage client 168 to execute data storage software, such as data storage software 112, which is described in further detail above with respect to FIG. 1. In some implementations, data storage software module 176 includes hardware in the form of a microprocessor on a single integrated circuit, related firmware, and other software for allowing the microprocessor to operatively communicate with other hardware of storage server 166. In some implementations, the data storage software is stored within memory hardware of data storage software module 176. For example, in implementations where data storage software module 176 includes a hard drive, the data storage software can be stored on the hard drive. In other implementations, the data storage software can be stored remotely with respect to storage client 168.

Encapsulation module 178 is a functional module of storage client 168 that includes a combination of hardware and software that allows storage server 166 to encapsulate an Ethernet payload within a SCSI payload. In some implementations, encapsulation module 178 is configured to provide encapsulation functionality relating to storage client 168 as described above with respect to steps 142 and 144 of method 140. Encapsulation module 178 can, for example, include hardware in the form of a microprocessor on a single integrated circuit, related firmware, and other software for allowing the microprocessor to operatively communicate with other hardware of storage client 168.

FIG. 5 is a diagram illustrating various aspects of an example storage server 180 during operation. Storage server 180 includes multiple physical FC ports 182, 184, 186, 188 physically connected to other networked devices within a SAN. The FC ports interface with a driver 190 configured to create virtualized Ethernet devices on storage server 180. In this example, driver 190 presents two virtualized Ethernet network devices 192 and 194 to the rest of the SAN. Driver 190 can map FC SCSI traffic on the FC ports 182, 184, 186, and 188 to a respective virtualized Ethernet network device. In some examples, the FC SCSI traffic can contain metadata that indicates which Ethernet network device to direct the traffic stream to and each physical FC port is able to support traffic streams for either Ethernet network device.

In this implementation, driver 190 presents each physical FC port 182, 184, 186, and 188 as a single SCSI device to the SAN. For example, each physical FC port can identify itself as a SCSI device using SCSI commands (e.g. INQUIRY) and responds to a set of specific SCSI commands. In some implementations, each FC port has access to each Ethernet network device to allow traffic from different FC Ports to be directed to the same or different virtualized Ethernet network devices.

In this implementation, driver 190 instantiates a two-node IP subnet with a first node being a virtualized Ethernet network device and a second node being an endpoint used by data storage software installed on a storage client. For example, driver 190 creates a first subnet in which first virtualized Ethernet network device 192 interfaces with an Internet Sockets API 200, which executes storage server process 196. In the example depicted in FIG. 5, driver 190 creates a second subnet in which second virtualized Ethernet network device 194 interfaces with Internet Sockets API 200, which executes storage server process 198. In some implementations, virtualized Ethernet network devices 192 and 194 can be configured and monitored using the standard Linux tool suite (e.g. ifconfig, tcpdump). In some implementations, processes of data storage software on a storage client can access the virtualized Ethernet network devices 192 and 194 using a standard Linux Socket API. As described above with respect to steps 146 and 148 of method 140, in some implementations, each virtualized Ethernet network device can be assigned a Unique Target Identifier (UTID). In such implementations, storage clients can interrogate SCSI devices corresponding to the actual FC ports 182, 184, 186, and 188 to determine which UTIDs are accessible through storage server 180. The storage client can then build a list of which SCSI devices are available for use with the data storage software.

FIGS. 6 and 7 illustrate an example use case 202 in which data is transferred between host 204 and target 206 in response to process instructions from a user process 208 and a host process 210, with FIG. 6 illustrating a first portion of the use case and FIG. 7 illustrating a second portion of the use case. For illustration, the description of FIGS. 6 and 7 make reference to elements of other example SANs described herein, such as SCSI targets on ports of a storage server, however it is appreciated that this use case can be applicable for any suitable network or network element described herein or otherwise.

As depicted in FIG. 6, at time 212 a user process 208 listens for activity on a port (port 0) of target 206. At time 214, host process 210 requests host 204 to connect to target 206. In this example, the connection is established via the command “Connect(CID=0)”. Target 206 then creates connection record 123, forwards the CID information and the quality of the SCSI status to host 204 and communicates with user process 208 to complete listening on port 0. At time 216, user process 208 requests 1024 bytes of data from host 204. In response, host process 210 instructs host 204 to send the requested data to target 206. After target 206 receives the requested data from host 204, target 206 confirms receipt of the data to user process 208 and indicates the SCSI status quality to host 204.

At time 218, user process requests 140 KB of data from host 204. In response, host process 210 instructs host 204 to send the requested data to target 206. Due to the size of the requested chunk of data, the data is provided to target 206 using multiple commands, with each command indicating whether there are additional commands forthcoming (e.g., Last=0 or 1). After target 206 receives the requested data from host 204, target 206 confirms receipt to user process 208 and indicates the SCSI status quality to host 204.

At time 220, host process 210 requests read of 1K of data. In this example, this is accomplished via a Packet In command (e.g., “Packet In (CID=123)”). In this example, the requested data is not available immediately and target 206 waits until the data is available before responding. In this implementation, target 206 is specified a maximum time from the client for which target 206 should wait before timing out. This maximum timer can, for example, be selected to be shorter than the client's SCSI driver timeout such that the SCSI driver does not timeout under normal circumstances. If the data is available before the time expires then the data is returned. However, if the time out expires then target 206 returns a response indicating the command timed out and the client can either resend the command or signal to the calling process that a timeout occurred. In this case, the requested data is not available before the timeout period and target 206 indicates to host 204 that the request has timed out. In some implementations, the SCSI timeout value can itself be increased in order to minimize the likelihood of timing out. At time 222, host 204 re-requests read of 1K of data via the Packet In command. In response to this request, target 206 responds by sending the requested data and additionally indicating the SCSI status quality to host 204.

At time 224, host process 210 requests read of 66K of data via a Packet In command. Due to the size of the requested chunk of data, the data is provided to host 204 using multiple commands, with each command indicating whether there are additional commands forthcoming (e.g., Last=0 or 1). At time 226, host process 210 requests host 204 to disconnect from target 206. Target 206 destroys the connection and forwards the connection ID (34567) to host 204 along with the SCSI status quality.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations.

As used herein, the term “provide” includes push mechanisms (e.g., sending data independent of a request for that data), pull mechanisms (e.g., delivering data in response to a request for that data), and store mechanisms (e.g., storing data at an intermediary at which the data can be accessed). Furthermore, as used herein, the term “based on” means “based at least in part on.” Thus, a feature that is described based on some cause, can be based only on the cause, or based on that cause and on one or more other causes.

Furthermore, it should be understood that the systems, apparatuses, and methods described herein can include various combinations and/or sub-combinations of the components and/or features of the different implementations described. Thus, features described with reference to one or more implementations can be combined with other implementations described herein.

What is claimed is:

1. A server comprising:
a communication module including a Fibre Channel (FC) port to connect over FC to a client running data storage software to receive from the client an Ethernet payload encapsulated within an FC Small Computer System Interface (SCSI) payload;
an extraction module to extract the Ethernet payload from the SCSI payload;
a virtualization module to virtualize an Ethernet network device on the server;
a forwarding module to forward the Ethernet payload to the virtualized Ethernet network device; and
an interface module to interface the virtualized Ethernet network device with the data storage software on the client.

2. The server of claim 1, wherein the interface module is to interface the virtualized Ethernet network device with data storage software via an Internet Socket Application Programming Interface (API).

3. The server of claim 1, wherein the extraction module is to extract multiple Ethernet commands from a single SCSI payload.

4. The server of claim 1,
wherein the virtualization module is to virtualize first and second Ethernet network devices on the server, and
wherein the virtualization module is to assign the first Ethernet network device a first Unique Target Identifier (UTID) and the second Ethernet network device a second UTID.

5. The server of claim 4,
wherein the forwarding module is to determine whether to forward the extracted Ethernet payload to the first virtualized Ethernet network device or the second virtualized Ethernet network device based on metadata in the extracted Ethernet payload, and
wherein the forwarding module is to forward the extracted Ethernet payload to the determined Ethernet network device.

6. The server of claim 1, wherein the virtualized Ethernet network device is configurable by the data storage software via socket API commands.

7. The server of claim 1, wherein the data storage software is installed on the server.

8. The server of claim 1, further comprising:
a storage module to archive data from the Ethernet payload.

9. The server of claim 8, wherein the storage module archives data on a Small Computer System Interface (SCSI) storage device via SCSI commands.

10. The server of claim 8, wherein the data in the Ethernet payload is deduplicated data.

11. A method comprising:
receiving, from a client running data storage software, an Ethernet payload encapsulated in a Fibre Channel (FC) Small Computer System Interface (SCSI) payload transmitted over FC;
extracting the encapsulated Ethernet payload from the SCSI payload;
forwarding the extracted Ethernet payload to a virtualized Ethernet network device; and
interfacing the virtualized Ethernet network device with the data storage software on the client.

12. The method of claim 11, further comprising:
virtualizing an Ethernet network device.

13. The method of claim 12, further comprising:
virtualizing a second Ethernet network device;
assigning a first Unique Target Identifier (UTID) to the first virtualized Ethernet network device; and
assigning a second UTID to the second virtualized Ethernet network device.

14. The method of claim 13, further comprising:
determining whether the extracted Ethernet payload should be forwarded to the first or second Ethernet device based on metadata in the Ethernet payload.

15. A non-transitory machine-readable storage medium encoded with Fibre Channel (FC) routing instructions executable by a processor, the instructions comprising:
instructions to virtualize an Ethernet network device on a storage server;
instructions to extract an encapsulated Ethernet payload from an FC Small Computer System Interface (SCSI) payload, the FC SCSI payload being received over FC from a client running data storage software;
instructions to forward the extracted Ethernet payload to the virtualized Ethernet network device; and
instructions to interface the virtualized Ethernet network device with the data storage software of the storage client.
